(19) United States
(12) Patent Application Publication
(10) Pub. No.: US 2018/0319055 A1
(43) Pub. Date: Nov. 8, 2018

(54) SYNTHETIC RESIN FOAMING MOLDING DIE, MANUFACTURING METHOD OF SYNTHETIC RESIN FOAMING MOLDED ARTICLE USING SAID MOLDING DIE, AND SYNTHETIC RESIN FOAMING MOLDED ARTICLE MOLDED BY SAID MANUFACTURING METHOD

(71) Applicant: BRIDGESTONE CORPORATION, Tokyo (JP)

(72) Inventors: Yousuke MUTA, Tosu-shi (JP); Kouhei MIZUTA, Tosu-shi (JP); Norihito IBI, Tosu-shi (JP)

(73) Assignee: BRIDGESTONE CORPORATION, Tokyo (JP)

(21) Appl. No.: 15/740,605

(22) PCT Filed: Jun. 22, 2016
(86) PCT No.: PCT/JP2016/068474

§ 371 Date: Dec. 28, 2017

(30) Foreign Application Priority Data
Jun. 29, 2015 (JP) 2015-129561

(51) Int. Cl. B29C 44/58; B29C 44/34; B29C 44/04

(52) U.S. Cl. CPC B29C 44/588; B29C 33/10; B29C 44/04; B29C 44/353

(57) ABSTRACT

The present invention provides a synthetic resin foaming molding die, a manufacturing method of a synthetic resin foaming molded article using the molding die, and a synthetic resin foaming molded article molded by the manufacturing method, which can prevent generation of a large-size void(s). The molding die (10) comprises an upper die (16) and a lower die (12) and having a cavity (29) defined by the upper die and the lower die, and a parting line 22 (communicating portion) communicating the cavity (29) and an ambient air. A rod-like member (24) is provided in fluid passage to allow the synthetic resin foaming material to flow to the parting line (22), in a protruding manner from the cavity surface.

### TECHNICAL FIELD

The present invention relates to a synthetic resin foaming molding die, a manufacturing method of a synthetic resin foaming molded article using the molding die, and a synthetic resin foaming molded article molded by the manufacturing method. In particular, the present invention relates to the synthetic resin foaming molded die which has a communicating portion communicating a molding space and an ambient air to discharge a foaming gas in the molding space, the manufacturing method of the synthetic resin foaming molded article using such molding die, and the synthetic resin foaming molded article molded by such manufacturing method.

### BACKGROUND ART

The synthetic resin foaming molded article, such as a polyurethane foam, is manufactured by pouring a synthetic resin foaming material into the synthetic resin foaming molding die which has a predetermined-shape molding space (cavity), causing the synthetic resin foaming material in the molding space to foam and harden, and then removing the molding die.

For obtaining a homogeneous synthetic resin foaming molded article, an internal pressure of the synthetic resin foaming molding die must be properly maintained to fill all the corners in the molding space with the synthetic resin foaming material securely. For such requirement, a communicating portion is provided which communicates the ambient air and the molding space (cavity) in the synthetic resin foaming molding die, to discharge the foaming gas adequately. The communicating portion discharges the foaming gas generated during foaming from the cavity to adjust a pressure in the molding space (foaming pressure) adequately.

In a foaming molding die disclosed in the patent literature 1, a vent hole for degassing is provided in a place where gas is easily gathered, and a concave groove communicating with this vent hole is provided in an upper die. Thus, fluidity of gas increases to eliminate a poor foaming, such as thickness shortage.

### Prior Art Literature

### Patent Literature

Patent Literature1: Japanese Utility Model Application Publication No. 115-85609

### Problems to be Solved by the Invention

In the foaming molding die of the patent literatures 1, a molding space of narrow width is formed between an upper die and a lower die, and gas generated from the foaming resin materials filled in the molding space reaches the vent hole through the concave groove. For this reason, gas is smoothly discharged to an exterior of the upper die to avoid generation of large gas collection. Further, the foaming resin material flows through the plural concave grooves provided in the upper die, and spreads smoothly to all the corners of the foaming space to prevent generation of thickness shortage.

However, the die in the above patent documents 1 is used for manufacturing a thin meat panel. That is, the molding space formed between the upper die and the lower die is, from the beginning, a thin space corresponding to a plate-like molded article. Thus, a technique in the patent literature 1 produces an effect in a situation where comparatively little amount of the foaming resin material is used as a raw material. The present invention supposes a molding die having a large volume of the molding space to contain a large amount of the foaming resin material like a seat pad. If the technique in the patent literature 1 is applied to the present invention, mere provision of the concave groove is considered difficult to completely eliminate the foaming gas.

In the foaming molding die, the communicating portion is formed in the border plane (parting line) between the upper die and the lower die, or it is formed by a degassing member. However, such communicating portion is difficult to discharge the foaming gas in molding space completely, and a part of the foaming gas, not having been discharged completely, may remain around the communicating portion to generate a poor foaming. If the foaming molded article has the size larger than a regular size resulted from the remaining foaming gas, the foaming molded article is considered as a defective article.

The present invention is made in view of the above-mentioned subject, and has an object to provide a synthetic resin foaming molding die, a manufacturing method of a synthetic resin foaming molded article using the molding die, and a synthetic resin foaming molded article molded by the manufacturing method, which can prevent generation of a large-size void(s).

### Means to Solve the Problems

For achieving the above object, a synthetic resin foaming molding die recited in claim 1 comprises an upper die and a lower die and having a cavity defined by the upper die and the lower die, and a communicating portion communicating the cavity and an ambient air, wherein a protruding portion is provided in fluid passage to allow the synthetic resin foaming material to flow to the communicating portion, in a protruding manner from the cavity surface.

With the above structure, on account of the existing protruding portion (rod-like member), the synthetic resin foaming material which flows toward the communicating portion can disturb the flow of the foaming gas flowing accompanied by the flow of the synthetic resin foaming material. Disturbance of the foaming gas flow can prevent incompletely discharged foaming gas gathering at one place to form the large gas collection, and can disperse it as the smaller gas collections around the communicating portion.

Accordingly, the remaining foaming gas collection can have the smaller size to suppress size of the void formed in a molded article.
Further, the existing protruding portion (plate-like member) serves to temporarily dam flow of the synthetic resin foaming material. The temporal damming of the synthetic resin foaming material can prolong the time period until the synthetic resin foaming material covers the degassing member, compared with the case where no plate-like member is provided, so that more foaming gas is discharged through the degassing member. Thus, an accumulation place of the foaming gas can be controlled. The degassing portion set in the place where the foaming gas accumulated can make the void to smaller size and reduce the number of the voids more efficiently.

The synthetic resin foaming molding die recited in claim 2 is featured by, in the synthetic resin foaming molding die recited in claim 1, the protruding portion is a rod-like member. With such feature, the protruding portion can be formed with simple structure, entailing no difficulty in the manufacturing, and the rod-like member can disturb the flow of the foaming gas flowing accompanied by the synthetic resin foaming material. Thus, the remaining foaming gas collection has smaller size to suppress the void to be formed in the molded article to smaller size.

The synthetic resin foaming molding die recited in claim 3 is featured, in the synthetic resin foaming molding die recited in claim 2, the protruding portion is a plate-like member of which a planer portion intersects with a flow of the synthetic resin foaming material. With such feature, the protruding portion can be formed with simple structure, and the plate-like member can dam the synthetic resin foaming material temporarily to discharge more foaming gas through the communicating portion. Thus, the size of void formed in a molded article can be suppressed smaller.

The synthetic resin foaming molding die recited in claim 4 is featured by, in the synthetic resin foaming molding die recited in claim 1, the rod-like member has a diameter of 2-10 mm and a height of 2-10 mm from the cavity surface. With such feature, the rod-like member as the protruding portion of adequate size can disturb the flow of the foaming gas flowing accompanied by the flow of the synthetic resin foaming material. Thus, the remaining foaming gas collection has smaller size to suppress the void to be formed in the molded article to smaller size.

The synthetic resin foaming molding die recited in claim 5 is featured by, in synthetic resin foaming molding die recited in claim 4, the plate-like member has a thickness of 1-7 mm, a width of 20-70 mm, and a height of 10-30 mm from the cavity surface. With such feature, the plate-like member as the protruding portion of proper size and shape can dam the synthetic resin foaming material temporarily to discharge more foaming gas through the communicating portion. Thus, the void formed in a molded article can be suppressed to smaller size.

The synthetic resin foaming molding die recited in claim 6 is featured by, in the synthetic resin foaming molding die recited in one of claims 1 to 5, the protruding portion is made of a material which is the same as a material forming the cavity surface. With such feature, the protruding portion can be formed easily on the upper surface of the cavity. That is, usage of the same material allows to produce the protruding portion and the molding die simultaneously. Further, the protruding portion and the synthetic resin foaming material have the same physical characteristic etc., so that the flow of the synthetic resin foaming material can be easily predicted.

The synthetic resin foaming molding die recited in claim 7 is featured by, in the synthetic resin foaming molding die recited in one of claims 1 to 6, the protruding portion is disposed 5-10 mm frontward the communicating portion in the fluid passage of the synthetic resin foaming material. With such feature, the temporal damming of the synthetic resin foaming material and dispersion of the foaming gas by the protruding portion can be carried out at the suitable position near the communicating portion. Thus, the poor foaming can be suppressed furthermore.

For achieving the above object, a manufacturing method of a synthetic resin foaming molded article uses a molding die for molding a synthetic resin foaming material, the molding die including an upper die and a lower die and having a cavity defined by the upper die and the lower die, and a communicating portion which communicates the cavity and an ambient air, recited in claim 8.

The manufacturing method comprising a material introducing step for introducing the synthetic resin foaming material into a molding die which comprises a lower die and an upper die provided with a protruding portion in the fluid passage through which the synthetic resin foaming material flows to the communicating portion in a protruding manner from the cavity surface, and a foaming/hardening step for foaming and hardening the introduced synthetic resin foaming molding material, after affecting the material introducing step, wherein the foaming/hardening step causes the synthetic resin foaming material to flow in the order of the protruding portion and the communicating portion.

With such method, in the foaming/and hardening step, the synthetic resin foaming molding material flows in the order of the protruding portion and the communicating portion. As a result, on account of the existing protruding portion (rod-like member), the synthetic resin foaming material can disturb the flow of the foaming gas flowing accompanied by the flow thereof. Disturbance of the foaming gas flow can prevent the incompletely discharged foaming gas from gathering at one place to form the large gas collection, and can disperse it as the small gas collections around the communicating portion. Further, the protruding portion (plate-like member) temporarily dams the flow of the synthetic resin foaming material. The temporal damming of the synthetic resin foaming material can prolong the time period until the synthetic resin foaming material covers the degassing member, compared with the case where no plate-like member is provided. As result, more foaming gas is discharged through the degassing member to control an accumulation place of the foaming gas. Accordingly, the degassing portion can be set at the place where the foaming gas accumulates to make the void to smaller size and to reduce the number of the voids more efficiently. The remaining synthetic resin collection can have smaller size to suppress the size of the void formed in the foaming molded article.

For achieving the above object, the synthetic resin foaming molded article recited in claim 9 is featured by foaming and hardening a synthetic resin foaming molding material using the foaming die according to claim 8, and having a concave portion molded in an exposed manner corresponding to protruding portion. With such feature, completed synthetic resin foaming molded article has the concave portion formed in the position corresponding to the above protruding portion. Accordingly, the concave portion can be used as a mark to judge immediately vicinity of the communicating portion susceptible to generation of defects such as the void. Thus, the void generating condition near the communicating portion can be confirmed more quickly.

### EFFECTS OF THE INVENTION

According to the synthetic resin foaming molding die, the manufacturing method of the synthetic resin foaming molded article using the molding die, and the synthetic resin foaming molded article molded by the manufacturing method, following effects are rendered. That is, the provided protruding portion dams temporarily the synthetic resin foaming material which flows in the fluid passage to the communicating portion, and disturbs the flow of the foaming gas flowing accompanied by the synthetic resin foaming material. As a result, the remaining foaming gas collection can be made smaller, and the void size can be suppressed smaller than the regular size. Thus, the synthetic resin foaming molded article can be improved in the manufacture yield thereof.

### BRIEF EXPLANATION OF THE DRAWINGS

FIG. 1 is a schematic section explanatory view of a synthetic resin foaming molding die according to the first embodiment of the present invention.

FIG. 2 is a partially enlarged view of the synthetic resin foaming molding die shown in FIG. 1.

FIG. 3 is a schematic section explanatory view of a synthetic resin foaming molding die according to the second embodiment of the present invention.

FIG. 4(a) is a partially enlarged view of the synthetic resin foaming molding die shown in FIG. 3, and FIG. 4 (b) is an schematic plan view of the molding die.

### EMBODIMENTS FOR CARRYING OUT THE INVENTION

Hereinafter, embodiments of the present invention will be explained in detail with reference to drawings. FIG. 1 is a schematic section explanatory view of the synthetic resin foaming molding die 10 according to the first embodiment of the present invention.

The synthetic resin foaming molding die 10 is composed of a lower die 12 which constitutes a main body portion, and upper die 16 and a core cylinder mold 14 which cover an open surface of the lower die 12 and are joined to the lower die 12. The upper die 16 and the core die 14 cooperate with the lower die 12 to form a molding space 29 corresponding to of product shape therebetween.

A synthetic resin foaming material 32 is poured into the lower die 12 and flows as shown by an arrow 100 during foaming molding. An area called as an extending portion and shown by a reference numeral 20 easily gathers the foaming gas. In view of this, a parting line 22 which serves as a communicating portion is provided with communicating with the molding space 29 in the extending portion area 20 where the foaming gas is easily gathered, to discharge the foaming gas. The foaming material 32 flows in the extending portion area 20 toward the parting line 22.

The first embodiment is characterized by single rod-like member 24 formed near the parting line 22 to serve as a communicating portion.

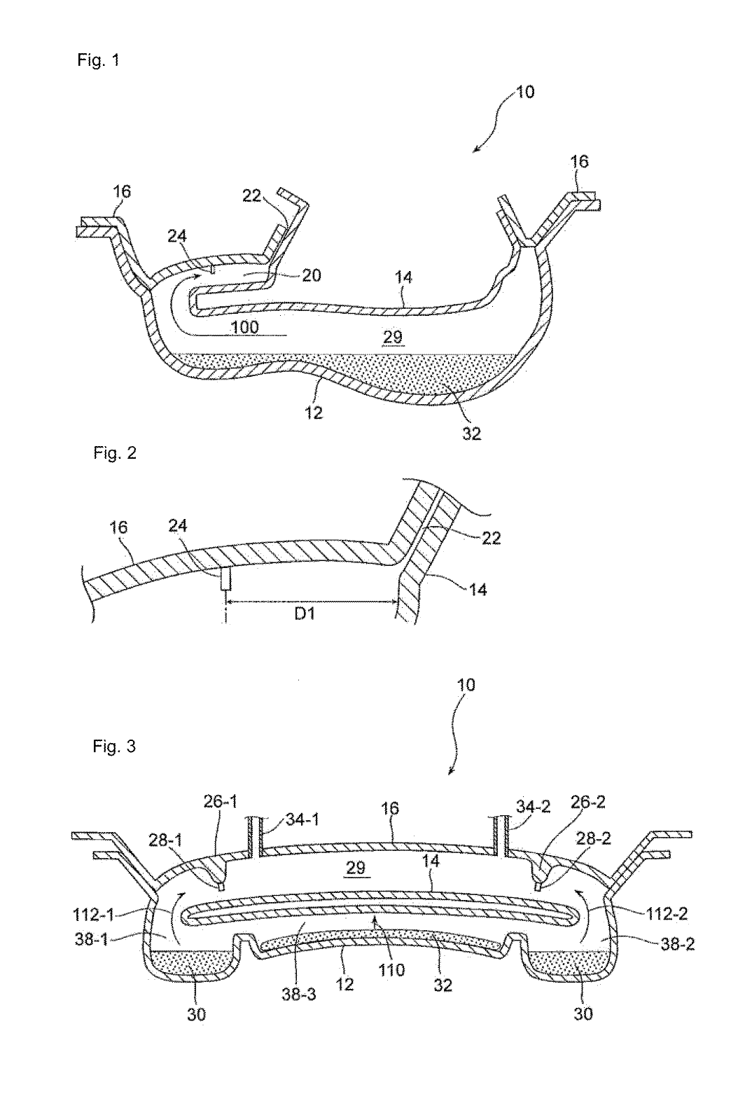

FIG. 2 is a partially enlarged expansion view of FIG. 1, and shows an installation structure of the rod-like member 24. As shown in FIG. 2, the rod-like member 24 is provided frontward the parting line 22 which serves as the communicating portion. An interval D1 between a center of the rod-like member 24 and the parting line 22 is set as 5 mm in this embodiment.

In the first embodiment, the rod-like member 24 has a diameter of 2 mm and a height of 4 mm. Further, the rod-like member 24 is characterized by made of the same materials as an upper surface (cavity upper surface) of the upper die 16. The foaming gas in the molding space 29 is discharged with its foaming gas pressure through the parting line 22 to an exterior of the molding space 29.

In FIG. 2, the synthetic resin foaming material flows toward the rod-like member 24. Accordingly, the foaming gas flowing accompanied by the synthetic resin foaming material is disturbed and dispersed by the rod-like member 24 provided. The dispersed foaming gas interferes with the foaming gas around the rod-like member 24. As a result, the foaming gas is adequately dispersed near the parting line 22, and is prevented from remaining as a large gas collection. Thus, formation of the large gas collection is prevented, which is resulted from the remaining gas gathered at one place due to disturbance and dispersion thereof, so that small voids are dispersed in the completed synthetic resin foaming molded article. Thus, in the molded article, generation of the large-size void larger than the regular size is avoided, which may lead to a defective article.

FIG. 3 shows a synthetic resin foaming molding die according to the second embodiment of the present invention, which corresponds to a vertical section in a depth direction of the extending portion area 20 of the synthetic resin foaming molding die 10 shown in FIG. 1. In FIG. 3, for elements which are the same as those of the synthetic resin foaming molding die 10 shown in FIG. 1, the same reference numerals are added and explanation thereof is omitted.

The second embodiment is characterized by a protruding portion formed by plate-like members 28 near the communicating portion (degassing member).

In FIG. 3, bulge portions 26-1, 26-2 bulged downwardly are formed on an upper die 16, which are intended to form design grooves in a seat back to be formed and molded. The design grooves are to be formed on a back portion of the seat back, that is on an upper surface of the back portion of both-ends areas 38-1 and 38-2. The plate-like members 28-1 and 28-2 which serve as the protruding portion are respectively formed on top portions of the bulge portion 26-1 and 26-2.

The plate-like member 28-1 and 28-2 are set with their plane portions intersected with the flow of synthetic resin foaming material. In this embodiment, preferably the plate-like members 28-1 and 28-2 are set in the direction orthogonal to the flow of synthetic resin foaming material. The plate-like member 28-1 and 28-2 are made of materials which are the same as that of the upper surface of the upper die 16, and in this embodiment, they have a thickness of 1 mm, a width of 20 mm and a height of 10 mm.

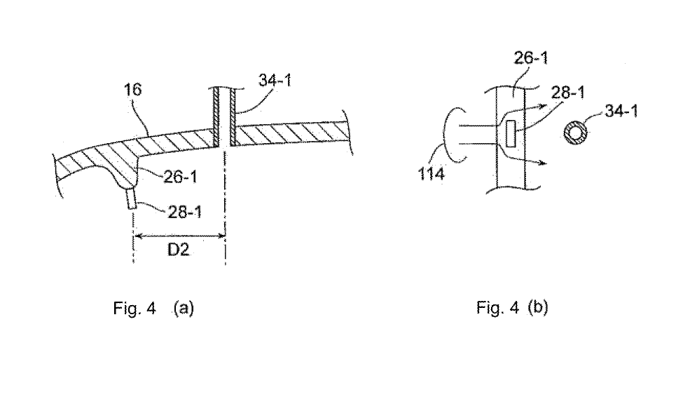

FIG. 4 shows a set structure of the plate-like member 28-1 and 28-2, that is, FIG. 4 (a) is a partially enlarged explanatory view of FIG. 3, and FIG. 4 (b) is a schematic plan view of the same. As shown, the plate-like member 28-1 is provided near the degassing member 34-1, such that an interval D2 between a center of the plate-like member 28-1 in the thickness direction and a center of the degassing member 34-1 is selected as 5 mm. Meanwhile, the plate-like member 28-2 and the degassing 34-2, not shown, are also arranged in the similar interval D2. The foaming gas in a molding space 29 is discharged with its foaming gas pressure through the degassing member 34-1 to an exterior of the molding space 29. For example, the embodiment may be configured such that a pressure regulation means (not shown) is connected to a tip of the degassing member 34-1, without sucking the molding space 29 externally through the degassing member 34-1, to enlarge a space which contains the foaming gas, when a pressure increases in the foaming gas from the molding space 29.

Meanwhile, the synthetic resin foaming material used here includes two kinds of materials having different hardness, that is, as shown in FIG. 3, material 30 of high hardness is poured into a bottom of the areas 38-1 and 38-2, and the poured synthetic resin foaming material 30 flows in the direction as shown by arrows 112-1 and 112-2. Material 32 of low hardness is poured into a central area 38-3 of the back portion, and flows in the direction as shown by an arrow 110. The embodiment is designed such that these materials which have the different hardness join at top portions of the bulged portion 26-1 and 26-2. However, in fact, a part of the foaming material 30 overrides the bulge portions 26-1 and 26-2, and join at an area shifted toward the central portion from the respective bulge portions 26-1 and of 26-2. For this reason, the foaming gas easily gathers at the area near this bulge portions 26-1 and 26-2 and shifted toward the central portion. In view of this, the degassing member 34-1 and 34-2 are provided in this area.

According to the second embodiment, the foaming gas flows together with the synthetic resin foaming material in a direction same as the flow 112-1 and 112-2. FIG. 4 (b) shows a flow 114 of the foaming gas near the plate-like member 28-1. The synthetic resin foaming material is temporarily dammed by this plate-like member 28-1. The temporal damming of the synthetic resin foaming material can prolong the time period until the synthetic resin foaming material covers the degassing member 34-1, compared with the case where no plate-like member 28-1 is provided, allowing more foaming gas to be discharged through the degassing member 34-1. That is, while the plate-like member 28-1 dams the synthetic resin foaming material, the foaming gas overrides the plate-like member 28-1, so that more foaming gas can be discharged through the degassing member 34-1. Further, a part of the foaming gas is dispersed as shown by flow of the foaming gas flow 114. As a result, a concentration of the foaming gas near the degassing member 34-1 is avoided, which may form the large gas collection, thereby preventing formation of the large-size void larger than the regular size void.

In the first embodiment and the second embodiment as mentioned above, the synthetic resin foaming molded article is obtained, by foaming and hardening the synthetic resin foaming material, and then removing the dies i.e., demolding. The foaming molded article thus obtained has a concave portion remaining corresponding to a protruding portion. That is, the foaming molded article of the first embodiment has a hole portion remaining corresponding to the rod-like member 24, and the foaming molded article of the second embodiment has a hole portion remaining at the bottom of a design groove corresponding to the plate-like members 28-1 and 28-2. The remained hole portion serves to judge place susceptible to generation of the void etc. i.e., a neighborhood of the communicating portion 22 (degassing member) 34-1, and 34-2 immediately, which assist to confirm the residual situation of the void quickly. Further, the void generating condition in the place can be quickly fed back to a manufacturing step such as a pouring pattern.

The embodiments of the synthetic resin foaming molding die, the manufacturing method of synthetic resin foaming molded article using molding die, and the synthetic resin foaming molded article molded by manufacturing method have been explained in detail. According to the molding die, the manufacturing method and the molded article, the communicating portions (degassing member) 22, 34-1, and 34-2 are provided in the place where the foaming gas is susceptible to collection, and the protruding portions 24, 28-1, and 28-2 are provided, in a fluid passage to which the synthetic resin foaming material reaches, with the communicating portion (degassing member) 22, 34-1, and 34-2. Such arrangement can prevent formation of the large gas collection of the foaming gas near the communicating portions (degassing member) 22, 34-1, and 34-2, and make size of the remained foaming gas collection smaller. As a result, formation of the large-size void larger than the standard size can be prevented. Further, the manufactured synthetic resin foaming molded article has the concave portion formed at the place corresponding to the protruding portion, the place susceptible to generation of the void etc. can judged immediately. In this way, a degree of the remained foaming gas can be confirmed and fed back immediately to the manufacture process, which increases a product yield of the synthetic resin foaming molded article.

Meanwhile, the present invention is not limited to the above-mentioned embodiments, and can include various modification made in the range without changing the gist of the invention. For example, size of the rod-like member 24 is not limited to the numerical value in the above-mentioned embodiment, but may have the diameter of 2-10 mm, the height of 2-10mm from the cavity surface, and the interval of 5-10 mm between the center of the rod-like member 24 and the center of the degassing member 22, according to the trial production result.

Instead of the single rod-like member 24 illustrated above, plural rod-like members 24 may be arranged in a pyramid shape for example, to enhance the dispersing effect of the foaming gas. Further, the rod-like members 24 may arrange side-by-side to dam flow of the synthetic resin foaming material temporarily, thereby preventing formation of the large gas collection.

Further, the plate-like members 28-1 and 28-2 as the protruding portion are not limited to the size in the above-mentioned embodiment, but may set in the thickness of 1-7 mm, the length of 20-70 mm, and the height of 10-30 mm, and the interval D2 of 5-10 mm between the center of the plate-like member 28-1 and 28-2 in the thickness direction and the center of the degassing member 30-1 and 30-2.

Further, when the plate-like members 28-1 and 28-2 serves as the protruding portions, the degassing member is illustrated as the communicating portion, but the parting line formed at a matching surface of the molding dies as the communicating portion can also suppress a poor foaming. Meanwhile, for eliminating the poor foaming more securely, when the plate-like member serves as the protruding portion, the degassing member (especially an auto vent) is preferably used as the communicating portion.

### EXPLANATION OF REFERENCE NUMERALS

10 synthetic resin foaming molding die
12 lower die
14 core die
16 upper die
20 extending portion area
22 parting line (communicating portion)
24 rod-like member (protruding portion)
26-1, 26-2 the bulge portion
28-1, 28-2 plate-like member (protruding portion)
29 molding space (cavity)
30 synthetic resin foaming material (hard)
32 synthetic resin foaming material (soft)
34-1 and 34-2 degassing member (communicating portion)
38-1 and 38-2 both ends of back portion
38-3 central portion of back portion
100, 112-1, 112-2 flow of synthetic resin foaming material
114 flow of foaming gas

1. A molding die for molding a synthetic resin foaming material, which comprises an upper die and a lower die and having a cavity defined by the upper die and the lower die, and a communicating portion communicating the cavity and an ambient air,
wherein a protruding portion is provided in fluid passage to allow the synthetic resin foaming material to flow to the communicating portion, in a protruding manner from the cavity surface.

2. The synthetic resin foaming molding die according to claim 1, wherein the protruding portion is a rod-like member.

3. The synthetic resin foaming molding die according to claim 1, wherein the protruding portion is a plate-like member of which a planer portion intersects with a flow of the synthetic resin foaming material.

4. The synthetic resin foaming molding die according to claim 2, wherein the rod-like member has a diameter of 2-10 mm and a height of 2-10 mm from the cavity surface.

5. The synthetic resin foaming molding die according to claim 3 wherein the plate-like member has a thickness of 1-7 mm, a width of 20-70 mm, and a height of 10-30 mm from the cavity surface.

6. The synthetic resin foaming molding die according to claim 1, wherein the protruding portion is made of a material which is the same as a material forming the cavity surface.

7. The synthetic resin foaming molding die according to claim 1, wherein the protruding portion is disposed 5-10 mm frontward the communicating portion in the fluid passage of the synthetic resin foaming material.

8. A manufacturing method of a synthetic resin foaming molded article using a molding die for molding a synthetic resin foaming material, the molding die including an upper die and a lower die and having a cavity defined by the upper die and the lower die, and a communicating portion which communicates the cavity and an ambient air, the manufacturing method comprising
a material introducing step for introducing the synthetic resin foaming material into a molding die which comprises a lower die and an upper die provided with a protruding portion in the fluid passage through which the synthetic resin foaming material flows to the communicating portion in a protruding manner from the cavity surface, and
a foaming/hardening step for foaming and hardening the introduced synthetic resin foaming molding material, after affecting the material introducing step,
wherein the foaming/hardening step causes the synthetic resin foaming material to flow in the order of the protruding portion and the communicating portion.

9. A synthetic resin foaming molded article obtained by foaming and hardening a synthetic resin foaming molding material using the foaming die according to claim 8, and having a concave portion molded in an exposed manner corresponding to protruding portion.
